(19) United States
(12) Patent Application Publication
(10) Pub. No.: US 2024/0257674 A1
(43) Pub. Date: Aug. 1, 2024

(54) Automatic Flag Displayer

(71) Applicant: Courtney McCutchen, San Angelo, TX (US)

(72) Inventor: Courtney McCutchen, San Angelo, TX (US)

(21) Appl. No.: 18/102,278

(22) Filed: Jan. 27, 2023

(51) Int. Cl. G09F 17/00

(52) U.S. Cl. CPC G09F 17/00

(57) ABSTRACT

The automatic flag displayer is a weather-proof device that can be mounted and used to display a flag during appropriate times, without needing someone to manually fetch the flag and roll or unroll it. Instead, the automatic flag displayer comes with a remote control with buttons to control the necessary actions of opening or closing the rubber-sealed shutter doors where the flag is stored when not flown, lowering or raising the flag, and rolling or unrolling the flag. When the rubber-sealed shutter doors open, the flag hinge and the associated flag hinged arm can be manipulated by said remote to angle the flag out of the box. The combination of the hinge and the hinged arm provide structural support to the flag and secure it against strong winds or other hazardous weather conditions.

### BACKGROUND

A flag is a piece of fabric (most often rectangular or quadrilateral) with a distinctive design and colors. It is used as a symbol, a signaling device, or for decoration. National flags are patriotic symbols with widely varied interpretations that often include strong military associations because of their original and ongoing use for that purpose. Flags are also used in messaging, advertising, or for decorative purposes. There have been no products available as original equipment or as an aftermarket to address this problem.

Hoisting the flag is the act of raising the flag on the flagpole. Raising or lowering flags, especially national flags, usually involves ceremonies and certain sets of rules, depending on the country, and usually involve the performance of a national anthem. Some rules of flag etiquette also apply to the lowering of the flag, and when the flag should be flown. For example, on special days, the flag may be flown at half-staff. On Memorial Day it is flown at half-staff until noon and then raised. There have been no products available as original equipment or as an aftermarket to address this problem either.

There exists a need for an automatic flag displayer that is not being met by any known or disclosed device or system of present.

### SUMMARY OF THE INVENTION

The automatic flag displayer is a weather-proof device that can be mounted and used to display a flag during appropriate times, without needing someone to manually fetch the flag and roll or unroll it. Instead, the automatic flag displayer comes with a remote control with buttons to control the necessary actions of opening or closing the rubber-sealed shutter doors where the flag is stored when not flown, lowering or raising the flag, and rolling or unrolling the flag. When the rubber-sealed shutter doors open, the flag hinge and the associated flag hinged arm can be manipulated by said remote to angle the flag out of the box. The combination of the hinge and the hinged arm provide structural support to the flag and secure it against strong winds or other hazardous weather conditions.

A flag display system includes a flag display device comprising a flagpole, a swivel pivot attached to an end of the flagpole, a stationary portion of the flagpole adjacent the swivel pivot end and a furling portion of the flagpole received into and extending beyond the stationary portion of the flagpole. The flag display system also includes a housing for the flag display device, the housing comprising a swing connection to the stationary portion of the flagpole and at least one hinged door configured to swing open and allow the flagpole to extend from the housing and a flag attached to the furling portion of the flagpole to unfurl.

### BRIEF DESCRIPTION OF THE DRAWINGS

FIG. 1 is a view of the automatic flag displayer when the flag is put away and the doors are closed in accordance with an embodiment of the present disclosure.

FIG. 2 is a view of the automatic flag displayer when the flag is out and the doors are open, but the flag is furled up in accordance with an embodiment of the present disclosure.

FIG. 3 is a view of the automatic flag displayer when the flag is out and unfurled for display with the doors open in accordance with an embodiment of the present disclosure.

FIG. 4 is a view of the automatic flag displayer for a furling storage operation in accordance with an embodiment of the present disclosure.

FIG. 5 is a view of the flag of the automatic flag displayer furled around the flagpole before storage in accordance with an embodiment of the disclosure.

FIG. 6 is a depiction of an inverted swing connection of the flagpole to the box upside down in accordance with an embodiment of the present disclosure.

FIG. 7 is a depiction of some mechanical components of the box to raise and lower and to furl and to unfurl the flag on the flagpole in accordance with an embodiment of the disclosure.

FIG. 8 is a depiction of some further control and mechanical components of the box in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘doors’ are used to refer to shutters and the like. The term ‘furl’ refers to a rolling up of a flag and ‘unfurl’ to an unrolling of the flag.

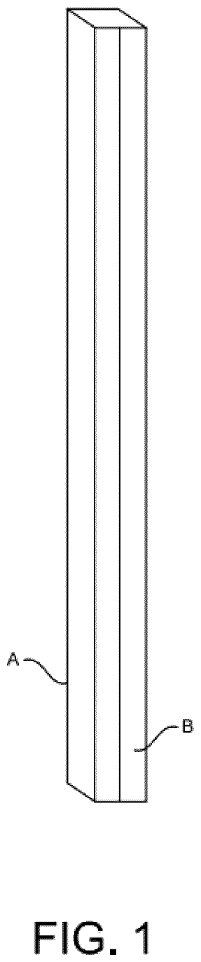

FIG. 1 is a view of the automatic flag displayer when the flag is put away and the doors are closed in accordance with an embodiment of the present disclosure. Shown is the weather-proof mount box A, with rubber sealed shutter doors B.

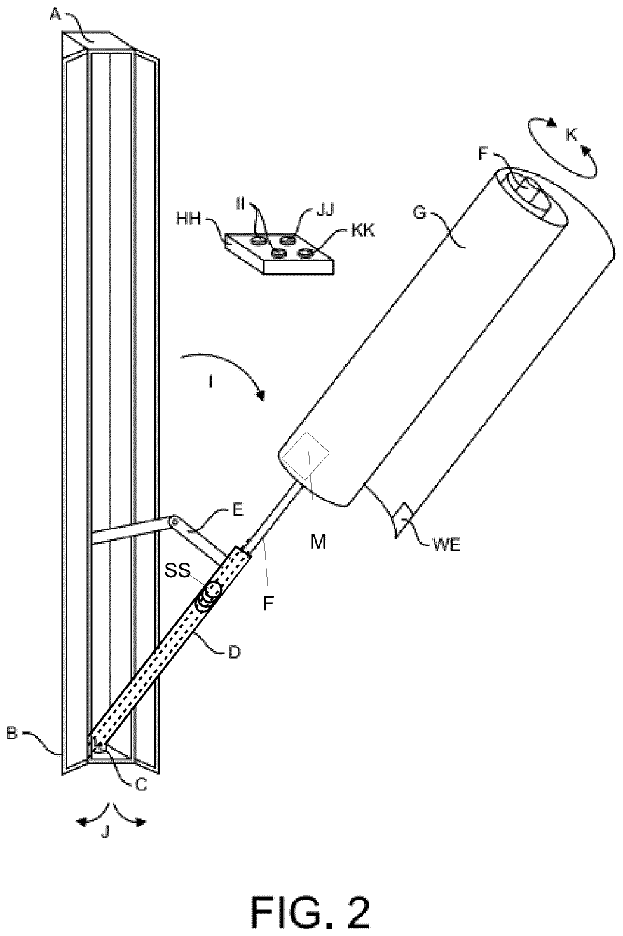

FIG. 2 is a view of the automatic flag displayer when the flag is out and the doors are open, but the flag is furled up in accordance with an embodiment of the present disclosure. Shown is the weather-proof mount box A, with rubber sealed shutter doors B. When the doors B open, the flag G may be lowered out of the box A on a swivable pivot hinge C. Additionally, a hinged arm, also known as a swing connection E holds the flag and its flag pole stationary portion D in place. The furling portion F slides within the stationary portion D. The automatic flag displayer is controlled by a remote control HH with four buttons: two buttons II to raise or to lower the flag, a button JJ to open or close the doors, and a button KK to roll out or roll up the flag. Degrees of motion are indicated in the present view including the furl and unfurl first degree of motion K, the flag raise and lower second degree of motion I and the flag mast swivel third degree of motion J as indicated by arrows. The weighted end WE helps the flag to unfurl and furl properly against a force of gravity on the weighted end WE. The magnet M is disposed to connect with a metallic weighted end to secure the furl of the flag but can be shaken lose when the flagpole drops from the box A. The spring SS is wound around the furling portion F against the stationary portion D of the flagpole to aid in a furling and an unfurling of the flag G.

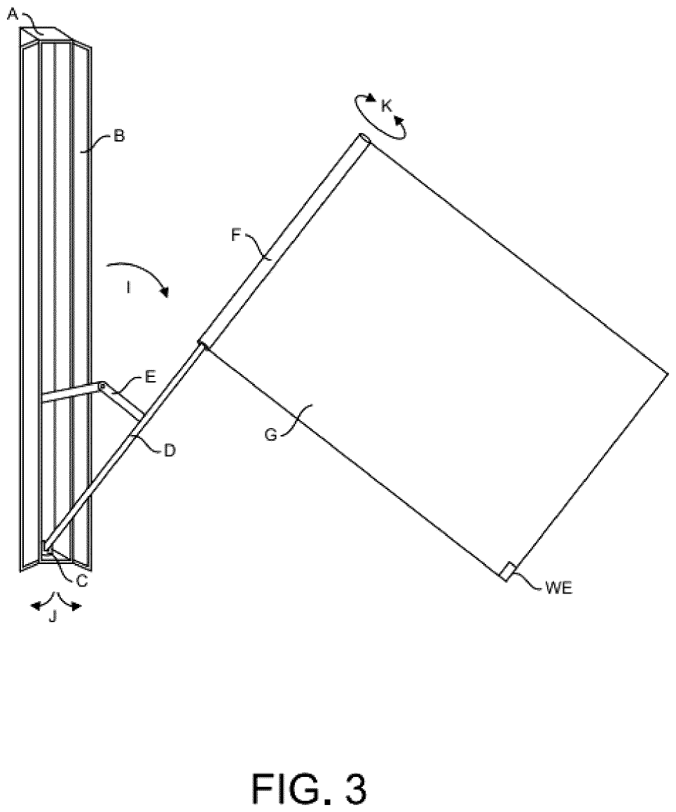

FIG. 3 is a view of the automatic flag displayer when the flag is out and unfurled for display with the doors open in accordance with an embodiment of the present disclosure. Same reference letters are used for similar and same limitations as those of FIG. 2 above. Shown is the weather-proof mount box A, with rubber sealed shutter doors B. When the doors open, the flag G may be lowered out of the box on a hinge C. Additionally, a hinged arm E holds the flag and its flag pole D in place. The automatic flag displayer is controlled by a remote control H (not depicted) with four buttons: two buttons II to raise or to lower the flag, a button JJ to open or close the doors, and a button KK to roll out or roll up the flag.

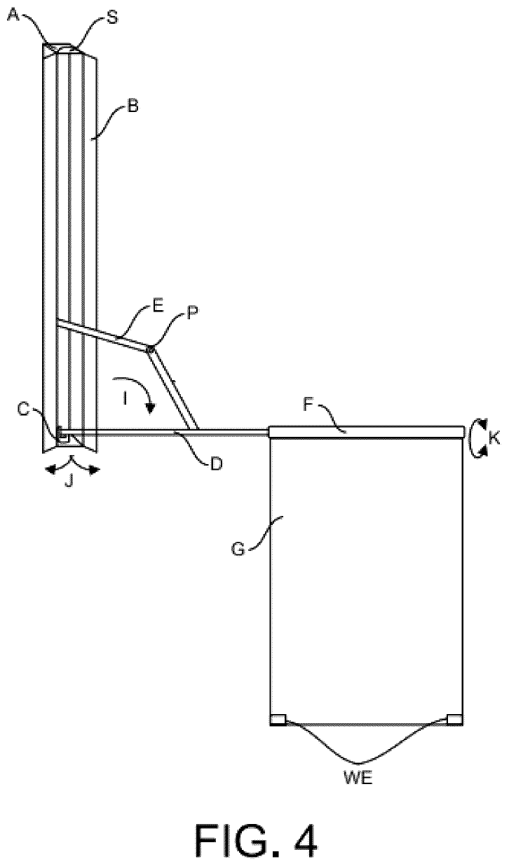

FIG. 4 is a view of the automatic flag displayer for a furling storage operation in accordance with an embodiment of the present disclosure. The view includes the limitations of the foregoing views and same or similar reference characters. The view also includes two weighted ends WE for superior automatic rolling of the fully extended ninety degree angle between the flag and the storage box. The pin P acts as a pivot hinge to the operation. Other embodied methods to open and close the disclosure are triggered by a day/night photosensor S. The photosensor S is a primary means to display the autoflag offering a “touchless” and automated experience. Alternating current (AC) and direct current (DC) power sources are included in the box A.

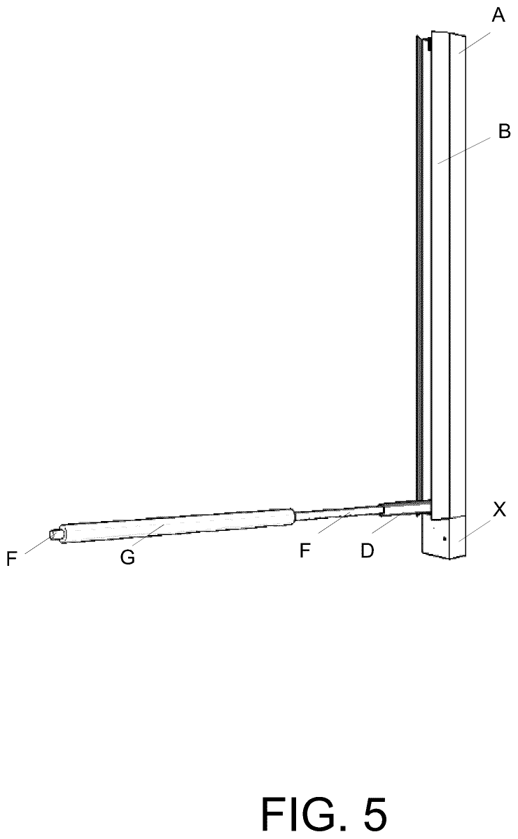

FIG. 5 is a view of the flag of the automatic flag displayer furled around the flagpole before storage in accordance with an embodiment of the disclosure. Same reference letters are used for similar and same limitations as those of other drawings herein. Additionally, a mechanical components and power box X is depicted at a bottom of the box A.

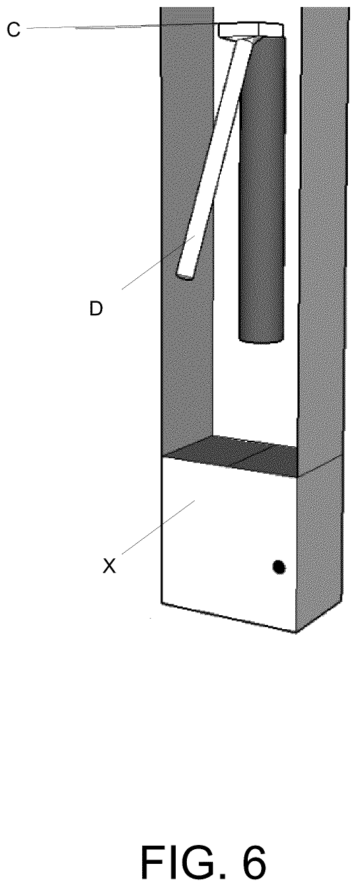

FIG. 6 is a depiction of an inverted swing connection of the flagpole to the box upside down in accordance with an embodiment of the present disclosure. The swivable pivot C is disposed at an inner top of the box A and the flagpole stationary portion D hangs upside down and swings out against gravity. The mechanical and power box X is shown with a single door and knob enclosure.

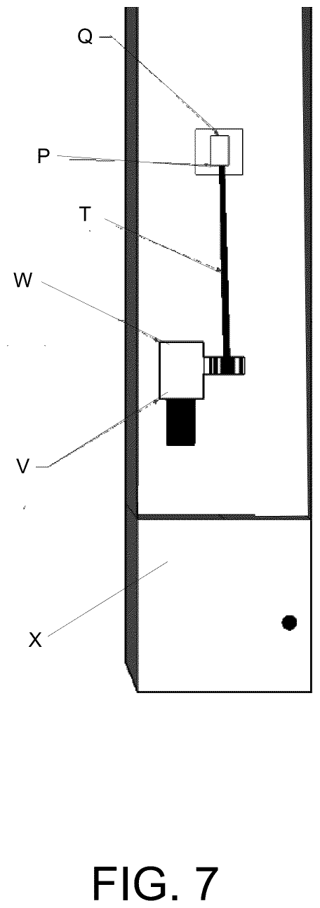

FIG. 7 is a depiction of some mechanical components of the box to raise and lower and to furl and to unfurl the flag on the flagpole in accordance with an embodiment of the disclosure. The depiction includes the paracord/shackle or tether coil Q, the pulley P, the paracord/cable T, the wormgear dc motor W and the bracket/holster V as disposed in an embodiment inside the box. The mechanical and power box X is thus in communication with the box wherein the flagpole is contained but separate thereto.

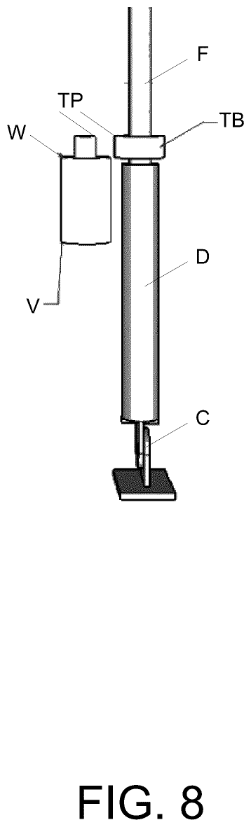

FIG. 8 is a depiction of some further control and mechanical components of the box in accordance with an embodiment of the present disclosure. The depiction includes the furling portion F of the flagpole, the timing belt TB, the timing pulley TP, the wormgear dc (direct current) motor W and the holster V relative to the stationary portion D of the flagpole and the swivable pivot C.

Embodiments of the disclosure include a rectangular box that stores the flag while not displaying flag. The rectangular box is able to be attached to any suitable structure. The flag extends from the box by command given from photocell, timer, Bluetooth command, wifi command, weather command, remote control and by operation buttons attached to unit. Once mounted, the box enables the flagpole to extend through box doors downward as the flag unrolls to a desired predetermined angle for display. Doors on box close behind the downward motion of flagpole. When command is given to the unit, the flagpole will retract in an upward direction and the pole will roll the flag around it and return to the box for storage with the box doors closing behind the flagpole.

Embodiments include push button controls for opening & closing the box doors, also known as butler doors, rotating the flagpole clockwise & counterclockwise, and tilting flagpole in and out of the box enclosure (up to 90 degrees from upright/vertical). Printed Circuit Board(s) (PCB) contain(s) programmable microcontroller, providing logic to automate all manual (pushbutton) controls.

The disclosure is battery operated with embodiments including solar panels with overcharge protection attached to the top of the box enclosure and replaced at the end-user's discretion to keep the battery sufficiently powerful.

The automated flag display routine includes the steps Open butler doors, Tilt rolled flag on flagpole to ˜60 degrees, Close doors, Unroll flag from flagpole, Display flag until user/environment enables the close routine. The Retract Routine includes steps Open doors, Lower flagpole to ˜90 degrees, Rotate flagpole to begin rolling flag up, As flag is wrapping around the flagpole, begin raising the flagpole back into the enclosure, Continue spinning flagpole when inside enclosure and close doors and Disable flagpole spin.

Further embodiments include a tunable phototransistor to provide dusk-to-dawn operation, basic routines for resetting the device and installing a new/different flag, battery monitoring, rain sensor, remote/app control, and a telescoping flagpole for half-mast display.

The disclosure can be fixed to any rigid structure. If the end user does not want their flag to touch the ground, a recommended installation height (top of enclosure) shall be 10 ft or greater (5 ft enclosure and 5 ft flag at 90 degrees). The enclosure and other materials can be negotiated with potential manufacturers. The current prototype is primarily 24-gauge sheet metal. A manufactured holster can be attached to the flagpole support and hold a DC Motor 1 (spin). Holster spacing will provide proper tension for timing belt.

An embodiment of the auto flag configuration includes the storage box attached to a suitable structure and the flagpole pivot disposed at a top of the flagpole. On command, the flag extends through the doors of the box in an upward instead of downward direction as the flag is rolled out and set at desired angle for display and the box doors close behind the flagpole on command or automatically. For storage and flag preservation in inclement weather, the flagpole retracts downward and rolls up the flag around the flagpole and back through the doors into the box with the doors closing behind it on command or automatically.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A flag display system comprising:
a flag display device comprising a flagpole, a swivel pivot attached to an end of the flagpole, a stationary portion of the flagpole adjacent the swivel pivot end and a furling portion of the flagpole received into and extending beyond the stationary portion of the flagpole; and
a housing for the flag display device, the housing comprising a swing connection to the stationary portion of the flagpole and at least one hinged door configured to swing open and allow the flagpole to extend from the housing and a flag attached to the furling portion of the flagpole to unfurl.

2. The system of claim 1, further comprising the flag having a weighted end to enable the flag to unfurl via a force of gravity on the weighted ends.

3. The system of claim 2, further comprising a magnet disposed on the flag complementary to the weighted end to attach thereto and secure the furl of the flag.

4. The system of claim 1, further comprising a spring wound around the furling portion of the flagpole against the stationary portion of the flagpole and configured to furl of the flag via a spring force of the spring greater than a weight force of the flag.

5. The system of claim 4, wherein a spring force of the spring is greater than a weight force of the flag but less than the weight force of the flag plus a weight force of a weighted end on the flag.

6. The system of claim 1, wherein the swing connection comprises one of a hinged arm, a rope tether and a chain tether.

7. The system of claim 1, further comprising a twisting motor adjacent the swivel pivot and attached to an end of the furling portion of the flagpole and configured to furl the flag and to unfurl the flag.

8. The system of claim 1, further comprising a twisting motor adjacent the swing connection and configured to coil a tether swing connection to furl the flag and to uncoil the tether swing connection to unfurl the flag.

9. The system of claim 1, wherein the swing connection is configured to swing from a vertical position parallel with the housing to within a ninety degree position from the housing based on an elbow hinge between two portions of the swing connection.

10. The system of claim 1, wherein the flagpole extends from an inside bottom of the housing and extends away from the housing with the force of gravity.

11. The system of claim 1, wherein the flagpole extends from an inside top of the housing and extends away from the housing against the force of gravity.

12. The system of claim 1, wherein the housing is adapted to mount the swivel pivot and the swinging arm within and enclose a flag attached to the flagpole.

13. The system of claim 1, wherein the flag unfurls in a first degree of motion via the flagpole and moves on the swivel pivot via the flagpole in a second degree of motion and extends from the housing via the swing connection on the flagpole in a third degree of motion.

14. The system of claim 1, further comprising a remote control for controlling the system via a wireless transceiver, an electronics control circuit and a servomechanism.

15. The system of claim 1, further comprising an electronic circuit and a servomechanism configured to unfurl and to furl the flag on the flagpole in a first degree of motion.

16. The system of claim 1, further comprising an electronic circuit and a servomechanism configured to move the flagpole on the swivel pivot in a second degree of motion.

17. The system of claim 1, further comprising an electronic circuit and a servomechanism configured to extend the flagpole from the housing via the swing connection in a third degree of motion.

18. The system of claim 1, further comprising an electronic circuit and a servomechanism configured to rotate the flagpole in a furling and in an unfurling first degree of motion.

19. The system of claim 1, further comprising an electronic circuit and a servomechanism configured to open the at least one hinged door on the housing.

20. The system of claim 1, further comprising a remote control configured to control a raising and a lowering of the flag, an opening and a closing of the at least one hinged door and a furling and an unfurling of the flag.
